(19) United States
(12) Patent Application Publication
(10) Pub. No.: US 2009/0248447 A1
(43) Pub. Date: Oct. 1, 2009

(54) REPORT GENERATION SUPPORT SYSTEM

(75) Inventors: Kenichi NIWA, Otawari-shi (JP); Hiroshizu Morishima, Ota-ku (JP); Masato Shibuya, Nasushiobara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 12/409,945

(22) Filed: Mar. 24, 2009

(30) Foreign Application Priority Data
Mar. 25, 2008 (JP) 2008-077396

(51) Int. Cl. G06Q 50/00; G06F 17/30; G06F 3/048

(52) U.S. Cl. 705/3; 707/3; 715/769; 707/E17.014

(57) ABSTRACT

A report generation support system has a storage that previously stores body-area information identifying various areas of a human body, and a display that displays a report generation screen, a medical image, and the body-area information. This report generation support system records a string into a radiology report in response to an operation of inputting the string and, in response to an operation of designating at least one medical image and the body-area information that are displayed, links the designated medical image and body-area information to the radiology report. Consequently, search of previous radiology reports connected to various areas of a human body is facilitated.

### BACKGROUND OF THE INVENTION

1. Field of the Invention

The present invention relates to a report generation support system configured to generate a radiology report in response to an operation and link a medical image to this radiology report.

2. Description of the Related Art

A medical image diagnosis apparatus generates medical image data.

Examples of the medical image diagnosis apparatus are an X-ray CT apparatus, an MRI apparatus, an ultrasound diagnosis apparatus, and a nuclear medical diagnosis apparatus. Medical image data generated by the medical image diagnosis apparatus is managed on an image server and is viewed on a terminal in a network. A report generation device configured to support generation of a radiology report receives a medical image from the image server and display the medical image on a monitor. A radiologist interprets the displayed medical image and generates a radiology report of the result of the interpretation by using the report generation device.

A report generation device may link a medical image to a radiology report. For example, as described in Japanese Unexamined Patent Application Publication JP-A 2005-301453, a report generation device generates link information representing the storage destination of a medical image and records the link information into a radiology report. Alternatively, the report generation device records the medical image into the radiology report in the process of linking the medical image.

Further, a radiologist may want to refer to a previous case when interpreting. A report generation device generally has a function as a search client. A radiologist inputs a phrase expected to be included in a radiology report that the radiologist wants to refer to, into the report generation device, and causes the report generation device to search a previous radiology report.

Examples of a phrase that can be inputted as a search criterion are a report ID, disease name, examined site, and examination date that are recorded on the header etc., other than the comment field as information identifying a report, or a phrase describing the result of interpretation inputted in the comment field of the radiology report.

The radiologist may want to refer to other cases regarding body areas identified by suspected sites, body areas identified by organs, and other segmentalized body areas. Since report information includes examined-site information representing a body site such as the head and the abdomen, the radiologist can cause the report generation device to search radiology reports in various areas on the basis of this site and can refer to other cases. However, the radiologist may want to refer to other cases regarding an area sectioned with a criterion different from the site. For example, the radiologist may want to refer to other cases regarding an area on the basis of an organ such as the stomach and the lung, or may want to refer to other cases regarding an area obtained by segmentalizing an organ such as the upper part of the stomach, or may refer to other cases regarding an area obtained by segmentalizing a site such as a shoulder. As for these areas sectioned with the criteria different from the site, the report information does not include the identification information, and therefore, it is difficult to search a radiology report with the report information as the search range.

It appears to be possible to search all text in the comment field with a phrase representing a suspected area as the search criterion and thereby refer to other cases regarding the area sectioned with the criterion different from the site as described above. However, since a sentence in the comment field is inputted by each radiologist, the sentence in the comment field may include no phrase representing a target area, or may describe a target area with a synonym. Therefore, even if all text in the comment field is searched with a phrase representing a suspected area as the search criterion, the accuracy of finding a radiology report that is worthy of reference will vary. Thus, according to the conventional technique, it is difficult to search a previous radiology report by using an area that can be sectioned on the basis of a different criterion from the site as the search criterion. Otherwise, a radiologist is required to exert considerable efforts.

### SUMMARY OF THE INVENTION

The present invention is made in consideration of the problems as described above, and an object of the present invention is to provide a report generation support system that can generate a radiology report in connection with an area in a human body and can search a radiology report with the area as the search criterion.

The report generation support system according to the present invention has a storage configured to store body-area information identifying various areas of a human body in advance, and a display configured to display a report generation screen, a medical image, and body-area information. In response to an operation of inputting a string, the report generation support system records the string into a radiology report. Then, in response to an operation of designating at least one medical image and the body-area information being displayed, the report generation support system links the designated medical image and body-area information to the radiology report. Consequently, it becomes easy to search previous radiology reports linked to various body areas.

As the linking, for example, designated body-area information may be recorded into the radiology report, or link information representing a storage destination of a designated medical image may be recorded into the radiology report, or a designated medical image may be recorded into the radiology report.

Further, the report generation support system may be configured to additionally store an object corresponding to body-area information into the storage, additionally display the object on the display and, in response to an operation of dropping a dragged medical image onto the object, link the dragged medical image and body-area information corresponding to the object with the medical image dropped, to a radiology report. Consequently, the body-area information is connected to the radiology report by a simple drag-and-drop operation, which is common linking, and a radiologist does not need to perform a complicated operation.

### BRIEF DESCRIPTION OF THE DRAWINGS

FIG. 1 illustrates the entire configuration of a report generation support system.

FIG. 2 illustrates screens displayed on a report generation device.

FIG. 3 illustrates the data configuration of a radiology report generated by the report generation device.

FIG. 4 illustrates the detailed configuration of the report generation device. FIG. 5 illustrates a mode for storing organ information.

FIG. 6 is a flow chart illustrating an example of a report generation operation by the report generation device.

FIG. 7 illustrates the configuration of a report storage device.

FIG. 8 illustrates a report database generated by the report storage device.

FIG. 9 illustrates a list to be generated.

FIG. 10 illustrates an example of a radiology report transmitted with a medical image.

FIG. 11 is a flow chart illustrating an operation of registering into the report database by the report storage device.

FIG. 12 is a flow chart illustrating an operation of searching the report database by the report storage device.

FIG. 13 is a flow chart illustrating another example of the report generation operation by the report generation device.

### DETAILED DESCRIPTION OF THE EMBODIMENT

A preferred embodiment of a report generation support system according to the present invention will be described in detail below with reference to the drawings.

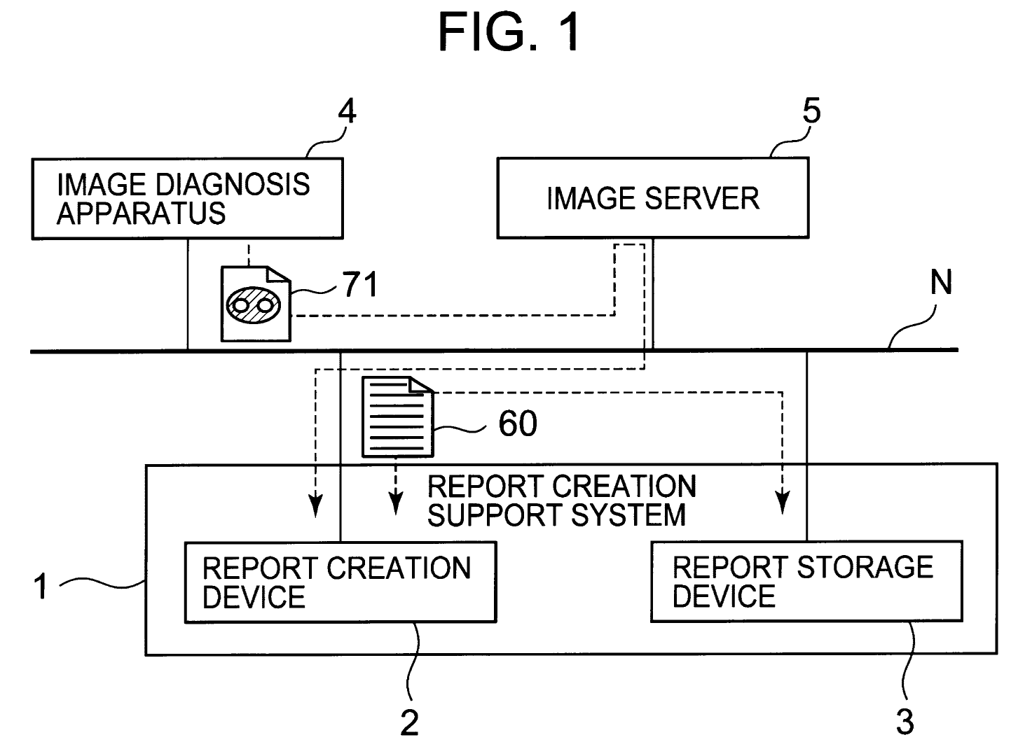

FIG. 1 is a block diagram illustrating the entire configuration of a report generation support system 1. The report generation support system 1 is composed by connecting a report generation device 2 with a report storage device 3 via a network N. This report generation support system 1 is connected to an image server 5 via the network N. To the network N, an image diagnosis apparatus 4 is connected. The image diagnosis apparatus 4 is a so-called modality such as an X-ray CT apparatus, an MRI apparatus, an ultrasound diagnosis apparatus, and a nuclear medical diagnosis apparatus.

The report generation device 2, the report storage device 3 and the image server 5 are so-called computers, each including a CPU (Central Processing Unit), a RAM (Random Access Memory), an HDD (Hard Disk Drive) and a communication controller, and are connected by shared lines so as to be capable of mutual input and output of data. The report generation device 2 is configured by connecting an input device such as a keyboard and a mouse, and a monitor such as a CRT display and a liquid crystal display, to a computer. Each of the HDDs stores an OS (Operating System) and a program for its own. The communication controller is directly connected to the network N, and controls data communication executed via the network N by data communication control of the WWW (World Wide Web) or DICOM (Digital Imaging and COmmunications in Medicine) data communication protocol, TCP/IP protocol, etc.

This report generation support system 1 provides a radiologist with an environment for interpreting a medical image 71 and an environment for generating a radiology report 60. The medical image 71 is an image of the inside of the body of a patient. The radiology report 60 is a document describing the result of interpretation of the medical image 71. In other words, the report generation support system 1 displays the medical image 71 to be interpreted, generates an electronic file of the radiology report 60, and executes search and display of previous radiology reports 60 that become reference cases.

The report generation device 2 acquires the medical image 71 from the storage destination and displays it. This is for the radiologist to interpret the medical image 71. The storage destination of the medical image 71 is the image server 5. The medical image 71 is generated by the image diagnosis apparatus 4. The image diagnosis apparatus 4 captures an image of a patient and generates the medical image 71 that reflects the result of the capture. The image diagnosis apparatus 4 transmits the generated medical image 71 to the image server 5. The image server 5 registers and stores the medical image 71 into an image database. When requested to interpret the medical image 71, the radiologist operates the report generation device 2 so as to acquire the medical image 71 from the image server 5. In response to the operation, the report generation device 2 accesses the storage destination of the medical image 71 to be interpreted, and acquires and displays the medical image 71 stored in the storage destination. The report generation device 2 generates an electronic file of the radiology report 60 in response to the operation of the radiologist. The report generation device 2 records letters into the radiology report 60, as well as links the medical image 71 and body-area information to the radiology report 60.

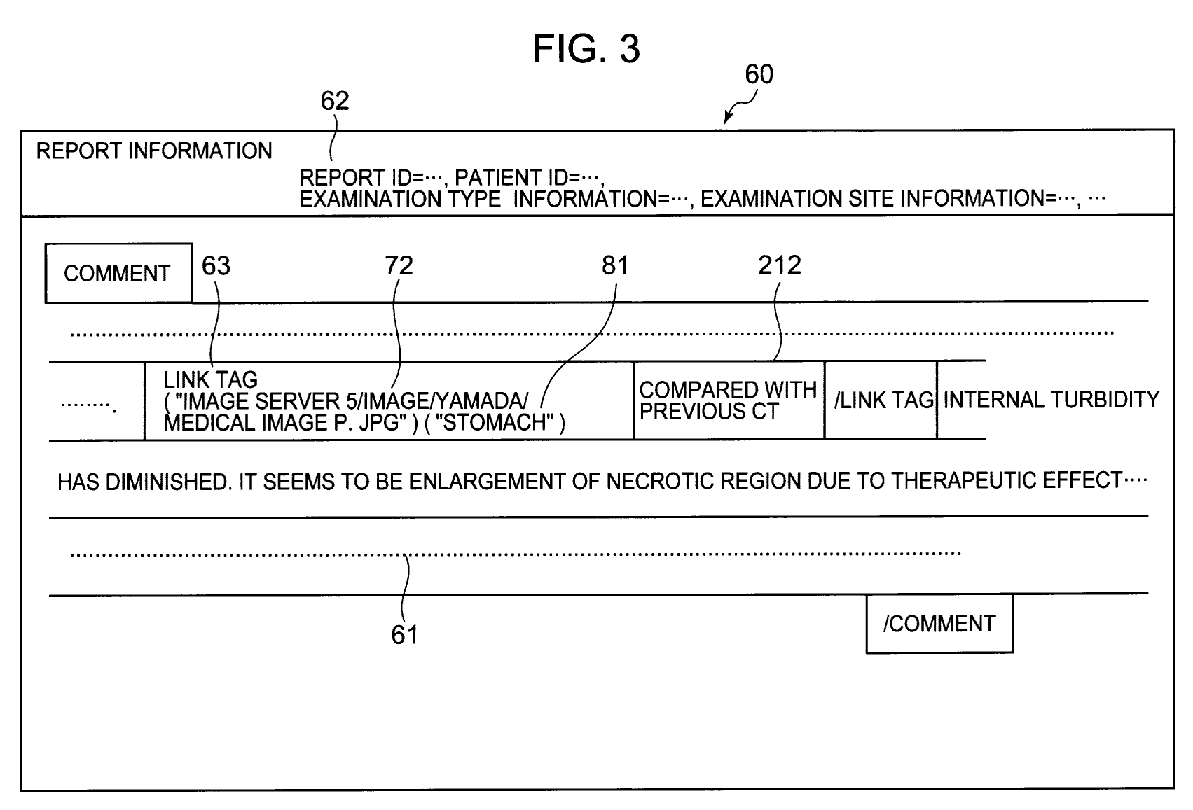

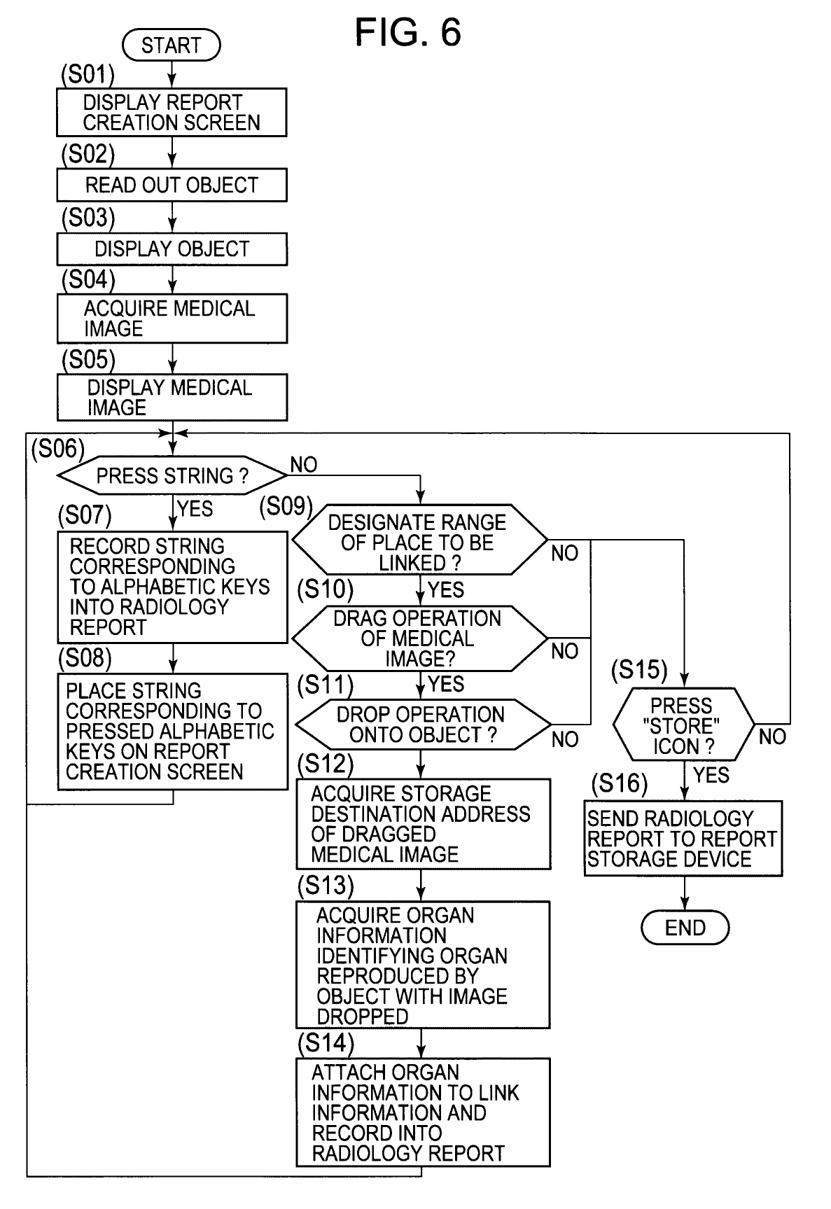

The body-area information is information identifying an area when a human body is sectioned by organization. The report generation device 2 links, to the radiology report, the body-area information identifying the area shown in the medical image 71 to be linked. In this embodiment, the report generation device 2 links organ information 81 (refer to FIGS. 3 and 6) identifying a section on the basis of an organ such as the stomach, the intestine and the large intestine, to the radiology report 60, as the body-area information.

Further, the report generation device 2 acquires a previous radiology report 60 that becomes a reference case from the report storage device 3 and displays it. The report generation device 2 acquires the radiology report 60 through search based on the search criterion.

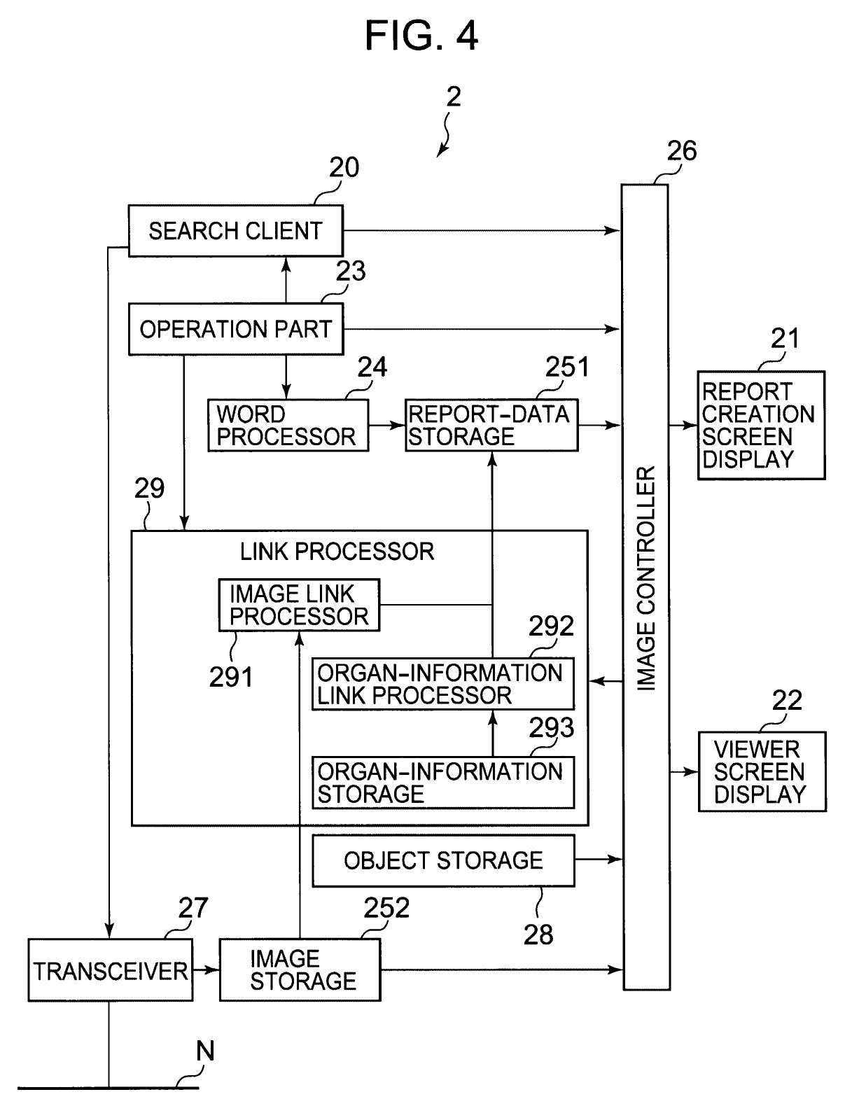

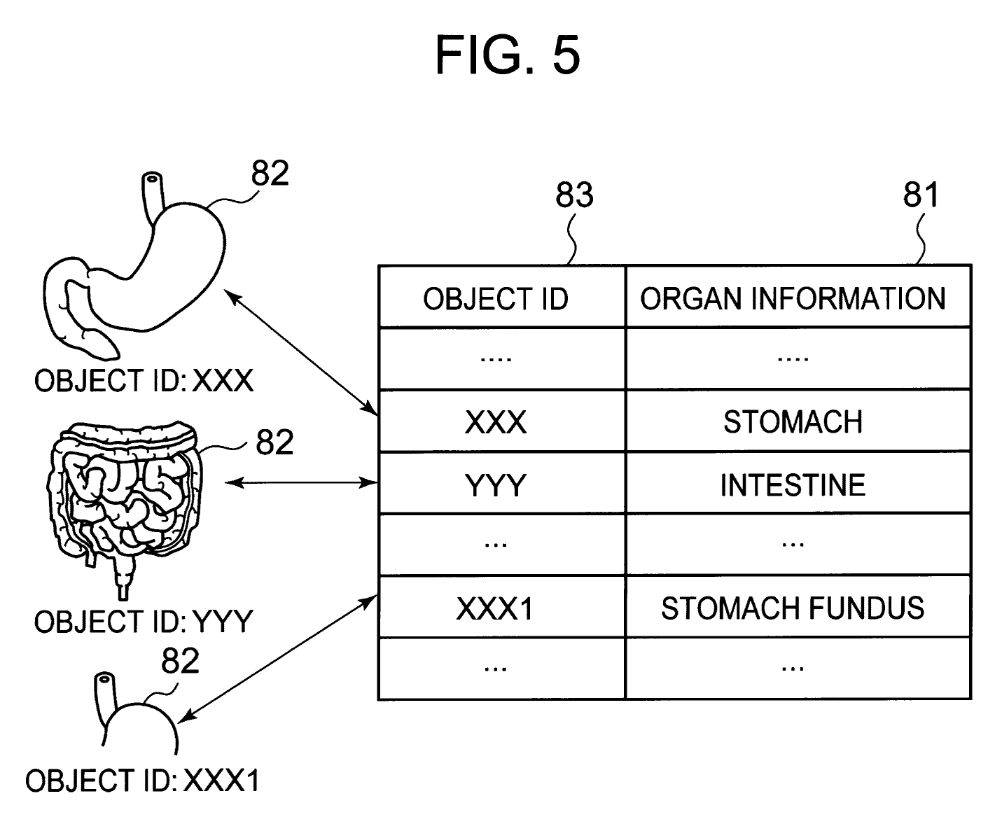

The report storage device 3 registers and stores the radiology report 60 into a report database 33 (refer to FIG. 4). The radiology report 60 generated by the report generation device 2 is transmitted to the report storage device 3. In a case that the previous radiology report 60 is referred to, the report storage device 3 searches the radiology report 60 satisfying the transmitted search criterion from the report database 33, and transmits the relevant radiology report 60 to the report generation device 2.

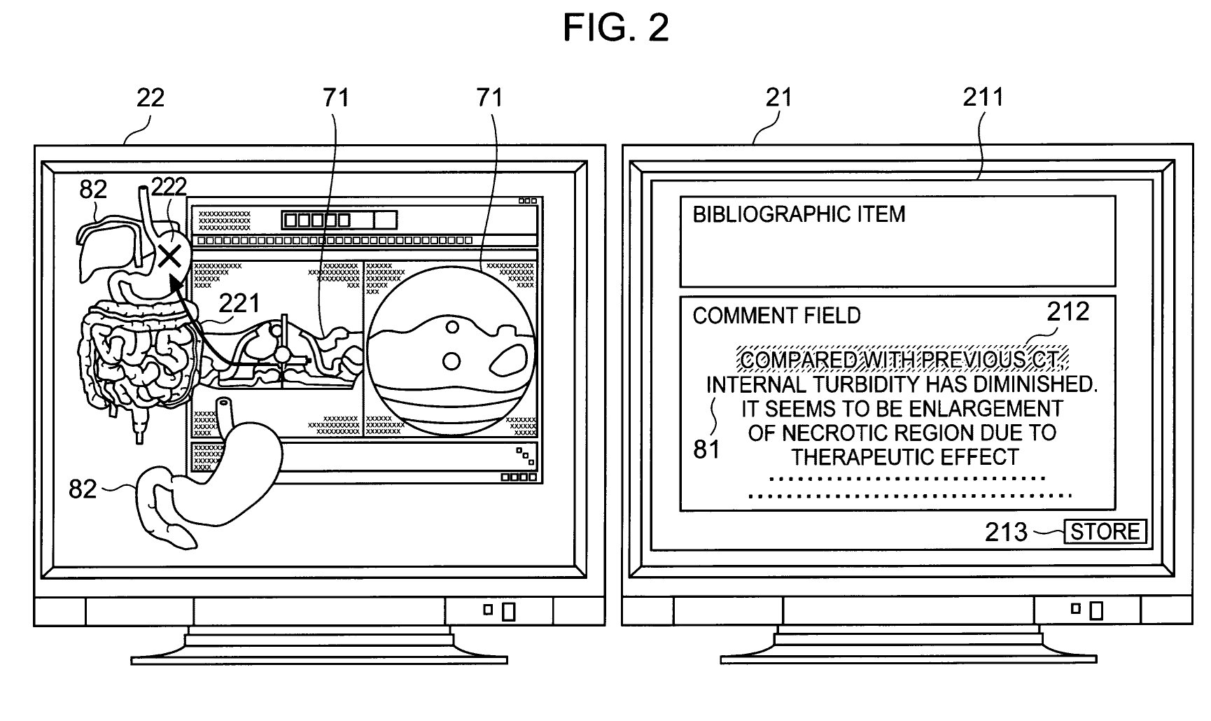

A mode of generation of the radiology report 60 by the report generation device 2 in the report generation support system 1 will be described. FIG. 2 is a schematic view illustrating screens displayed on the report generation device 2. FIG. 3 is a view illustrating the data configuration of the radiology report 60 generated by the report generation device 2.

As shown in FIG. 2, the report generation device 2 has two monitors.

A report generation screen display 21 is a monitor that displays a report generation screen 211. A viewer screen display 22 is a monitor that displays the medical image 71. The report generation screen 211 is a screen that displays the radiology report 60, and the data recorded in the radiology report 60 is reflected. The radiologist views and interprets the medical image 71 displayed on the viewer screen display 22. The radiologist makes the radiology report 60 of the result of interpretation by pressing alphabetic keys on a keyboard while referring to the report generation screen 211. On the report generation screen 211, a string 61 associated with the pressed alphabetic keys is placed. On the report generation screen 211, an icon 213 associated with a storage process is placed. When this icon 213 is pressed with a mouse, the report generation device 2 determines the data content of the radiology report 60 displayed on the report generation screen 211, and transmits it to the report storage device 3.

On the viewer screen display 22, an object 82 is displayed in addition to the medical image 71. The object 82 is a figure that reproduces an area of a human body, and the sectioning is at the same level as the body-area information. For example, when the body-area information is organ information 81, the object 82 reproducing the stomach, the liver and the intestine is displayed. This object 82 is a drop area from which a process of linking the medical image 71 starts. When a specified range 212 in the string 61 to which the medical image 71 is linked is designated by operating the mouse, and thereafter, a drag operation 221 of the medical image 71 as a link target is executed and a drop operation 222 is executed on the object 82, the dragged medical image 71 is linked to the string 61 in the specified range 212.

Additionally, the organ information 81 identifying the organ reproducing the object 82 is linked to the radiology report 60. In other words, through a linking process in which the object 82 reproducing the organ displayed in the medical image 71 is the drop destination, the organ information 81 for identifying the organ to be interpreted is connected to the radiology report 60.

Here, the drag operation 221 is an operation of grasping the medical image 71, specifically, an operation of positioning the cursor on the medical image 71, pressing down the button of the mouse, and then moving the mouse while pressing down the button of the mouse. Further, the drop operation 222 is an operation of dropping the medical image 71, specifically, an operation of releasing the pressed button of the mouse during the drag operation 221.

As shown in FIG. 3, a report ID 62 identifying the radiology report 60 and the string 61 corresponding to the press of the alphabetic keys are recorded in the radiology report 60. When the medical image 71 is linked to the specified range 212 of the string 61 of the radiology report 60, link information 63 is recorded into the radiology report 60. The link information 63 is composed of a link tag, an end tag thereof, and a storage destination address 72 attached to the link tag. The link tag and the end tag are recorded in the radiology report 60 so as to enclose the string 61 of the specified range 212 subject to the link. The storage destination address 72 is information that represents the storage destination of the linked medical image 71. As one mode of the link of the organ information 81 to the radiology report 60, the organ information 81 is recorded into the radiology report 60. More specifically, the organ information 81 is attached to the link tag. The organ information 81 attached to the link tag is information that identifies the organ reproduced by the object 82 with the medical image 71 dropped.

FIG. 4 is a block diagram illustrating the detailed configuration of the report generation device 2 in the report generation support system 1. The report generation device 2 has an operation part 23, a word processor 24, a report-data storage 251, an image storage 252, an image controller 26, a transceiver 27, an object storage 28, a link processor 29, and a search client 20.

The operation part 23 includes a keyboard and a mouse. The search client 20, the word processor 24, and the image controller 26 are each chiefly composed of a CPU. The report-data storage 251, the image storage 252, and the object storage 28 are each chiefly composed of a RAM and an HDD. The link processor 29 is chiefly composed of a CPU and an HDD. The transceiver 27 is chiefly composed of a communication controller.

The word processor 24 associates various alphabetic keys and the strings 61. When the alphabetic keys are pressed by the radiologist, the word processor 24 records the string 61 associated with the pressed keys into the radiology report 60 stored in the report-data storage 251.

The image controller 26 generates images for the screens to be displayed in the the report generation screen display 21 and the viewer screen display 22, and outputs the images to the report generation screen display 21 and the viewer screen display 22. For display control of the report generation screen 211, a format of the report generation screen 211 is set in advance. By placing the strings 61 recorded in the radiology report 60 in response to the input operations using the operation part 23 are placed in this format, the report generation screen 211 is generated. For display control of the screen to be displayed in the viewer screen display 22, the medical image 71 and the object 82 are displayed. The medical image 71 is acquired via the transceiver 27 through the network N and is stored into the image storage 252. The object 82 is stored in the object storage 28 in advance. When the object 82 is dragged with the mouse, the image controller 26 re-draws the object 82 at the drag destination.

The link processor 29 links the medical image 71 and the organ information 81 to the radiology report 60. This link processor 29 has an image link processor 291, an organ-information link processor 292, and an organ-information storage 293. The image link processor 291 and the organ-information link processor 292 are each chiefly composed of a CPU. The organ-information storage 293 is chiefly composed of an HDD.

The image link processor 291 links the medical image 71 to the radiology report 60. To be specific, the image link processor 291 records the link information 63 of the medical image 71 into the radiology report 60.

More specifically, the image link processor 291 generates a link tag including the storage destination address 72 of the dragged medical image 71 and an end tag thereof, and records the link tag and the end tag into the radiology report 60 so as to enclose the string 61 of the specified range 212.

Here, information such as an ID of the medical image 71 included in the storage destination address 71 is acquired from the attached information of the medical image 71 stored in the image storage 252.

The organ-information link processor 292 links the organ information 81 to the radiology report 60. To be specific, the organ-information link processor 292 records the organ information 81 into the radiology report 60.

The organ information 81 is read out of the organ-information storage 293.

FIG. 5 is a view illustrating a mode of storing the organ information 81.

The organ information 81 is paired with an object ID 83 and stored.

The paired object ID 83 is information that identifies the object 82 stored in the object storage 28. The object ID 83 of the object 82 showing the organ represented by the organ information 81 is associated with the organ information 81. The organ-information link processor 292 reads out, from the organ-information storage 293, the organ information 81 associated with the object ID 83 of the object 82 into which the medical image 71 has been dropped. The organ-information link processor 292 then attaches the organ information 81 to the link tag of the link information 63 recorded through an operation of designating the medical image 71, and records them into the radiology report 60.

The search client 20 requests the report storage device 3 to search a radiology report. The search client 20 generates the criterion for the report storage device 3 searching the radiology report 60, causes the transceiver 27 to transmit the criterion, and acquires a list of radiology reports 60. The image controller 26 controls the report generation screen display 21 to display the list of the radiology reports 60 having been acquired. Further, in response to an operation of selecting a radiology report 60 from the list by using the operation part 23, the search client 20 causes the transceiver 27 to transmit the report ID 62 of the radiology report 60, thereby requesting the report storage device 3 to acquire the radiology report 60.

The transceiver 27 communicates with the image server 5 and the report storage device 3 to transmit and receive data. The transceiver 27 acquires, from the image server 5, the medical image 71 existing in the storage destination associated with the storage destination address 72 inputted through operation of the operation part 23, and stores the medical image 71 into the image storage 252. The transceiver 27 acquires the medical image 71 by, for example, the query/retrieve system. Further, the transceiver 27 transmits, to the report storage device 3, the radiology report 60 stored in the report-data storage 251. Further, the transceiver 27 transmits the criterion for search and the request for selection generated by the search client 20 to the report storage device 3, and receives the searched list of radiology reports 60 and the selected radiology report 60 from the report storage device 3.

FIG. 6 is a flow chart illustrating an example of a report generating operation by the report generation device 2. First, the image controller 26 controls the report generation screen display 21 to display the report generation screen 211 (SOI). Further, the image controller 26 reads out the object 82 stored in the object storage 28 (S02), and controls the viewer screen display 22 to display the object 82 (S03). For example, the objects 82 that reproduce the stomach, intestine, liver, etc., respectively, are stored in the object storage 28, and the objects 82 are displayed by the viewer screen display 22. The positional relationship for displaying the objects 82 reproducing the stomach, intestine, liver, etc., is defined beforehand, whereby the objects 82 are displayed in the same positional relationship as in a human body.

The transceiver 27 acquires, via the network N, the medical image 71 presented by the storage destination address 72 specified through operation of the operation part 23, and stores the medical image 71 into the image storage 252 (S04). The image controller 26 reads out the medical image 71 from the image storage 252, and controls the viewer screen display 22 to display the medical image 71 (S05).

When the alphabetic keys of the operation part 23 are pressed (S06, Yes), the word processor 24 records the string 61 associated with the pressed alphabetic keys into the radiology report 60 (S07). Further, the image controller 26 generates the report generation screen 211 in which the string 61 associated with the pressed alphabetic keys is placed, and controls the report generation screen display 21 to display the string 61 (S08).

When the range of a place to link is designated with the mouse of the operation part 23 (S09, Yes), the drag operation 221 of the medical image 71 displayed in the viewer screen display 22 is executed (S10, Yes), and the drop operation 222 of dropping onto the object 82 displayed in the viewer screen display 22 is executed (S11, Yes), a linking process by the link processor 29 is started.

In the linking process, the image link processor 291 acquires the storage destination address 72 of the medical image 71 on which the drag operation 221 has been executed (S12). Information that forms the storage destination address 72 is acquired from the attached information of the medical image 71. The storage destination address 72 is generated based on the information acquired from the attached information. At the same time, based on the object ID 83 of the object 82 into which the medical image 71 has been dropped, the organ-information link processor 292 acquires the organ information 81 that identifies the organ reproduced by the object 82, from the organ-information storage 293 (S13).

When acquiring the storage destination address 72 and the organ information 81, the image link processor 291 and the organ-information link processor 292 attach the organ information 81 to the link information 63 including the storage destination address 72, and record them into the radiology report 60 in association with the string 61 of the specified range 212 (S14).

When the icon 213 for storing is pressed down with the mouse of the operation part 23 (S15, Yes), the transceiver 27 reads out the radiology report 60 from the report-data storage 251, and transmits the radiology report 60 to the report storage device 3 (S16).

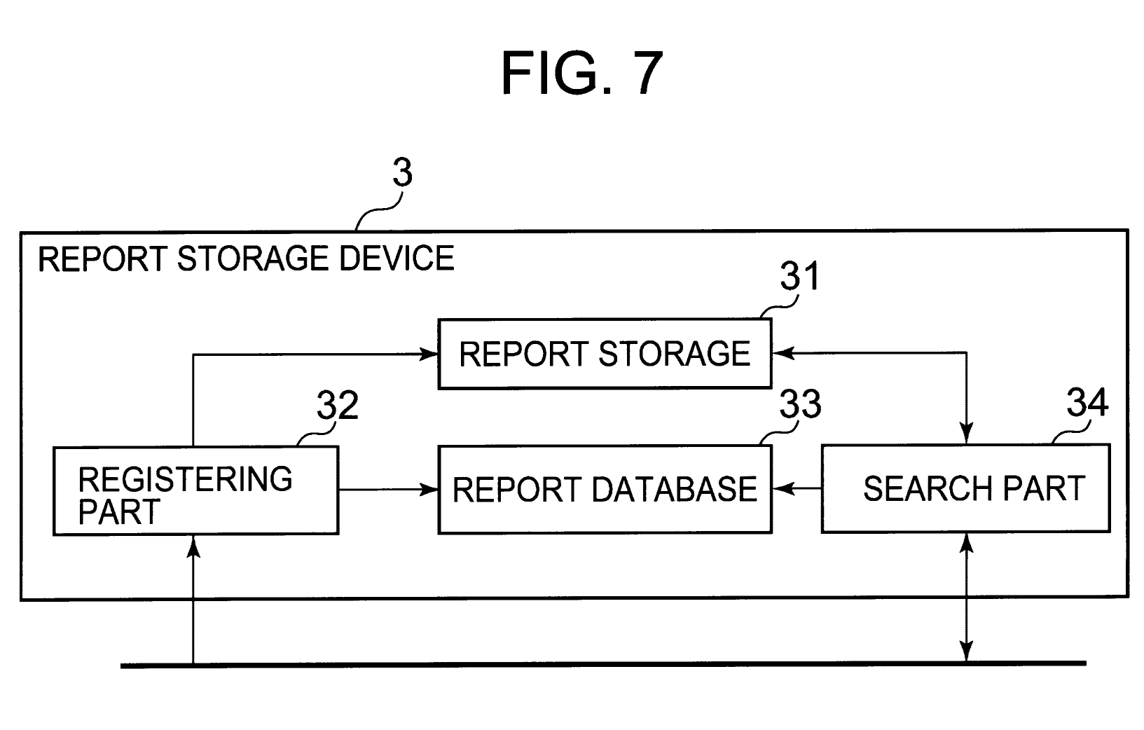

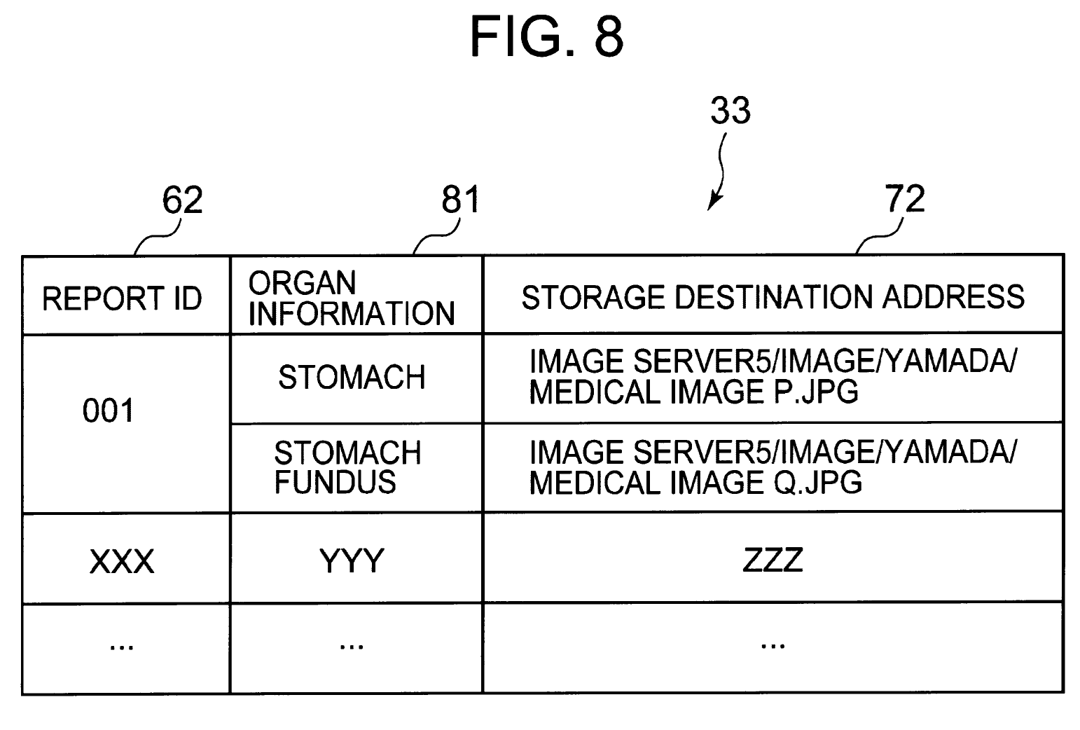

Next, generation of a report database 33 and search of a radiology report 60 in the report storage device 3 of the report generation support system 1 will be described. FIG. 7 is a block diagram illustrating the configuration of the report storage device 3. FIG. 8 is a data configuration view illustrating the report database 33 generated in the report storage device 3.

The report storage device 3 includes a report storage 31, a registering part 32, a report database 33, and a search part 34. The report storage 31 and the report database 33 are each chiefly composed of an HDD. The registering part 32 and the search part 34 are each chiefly composed of a CPU.

The report storage 31 stores the radiology reports 60 received from the report generation device 2. The registering part 32 registers the radiology reports 60 received from the report generation device 2 into the report database 33. As shown in FIG. 8, the report ID 62, the organ information 81, and the storage destination address 72 are stored in combination in the report database 33. The registering part 32 reads out the report ID 62, the organ information 81, and the storage destination address 72 from the received radiology report 60, and registers them in combination into the report database 33. Both the organ information 81 and the storage destination address 72 to be combined are information included in the same link tag. In a case that the medical image 71 is pasted to the radiology report 60, the report ID 62 and the organ information 81 are registered in pair.

The search part 34 searches radiology reports 60 with reference to the report database 33, and generates a list of the relevant radiology reports 60.

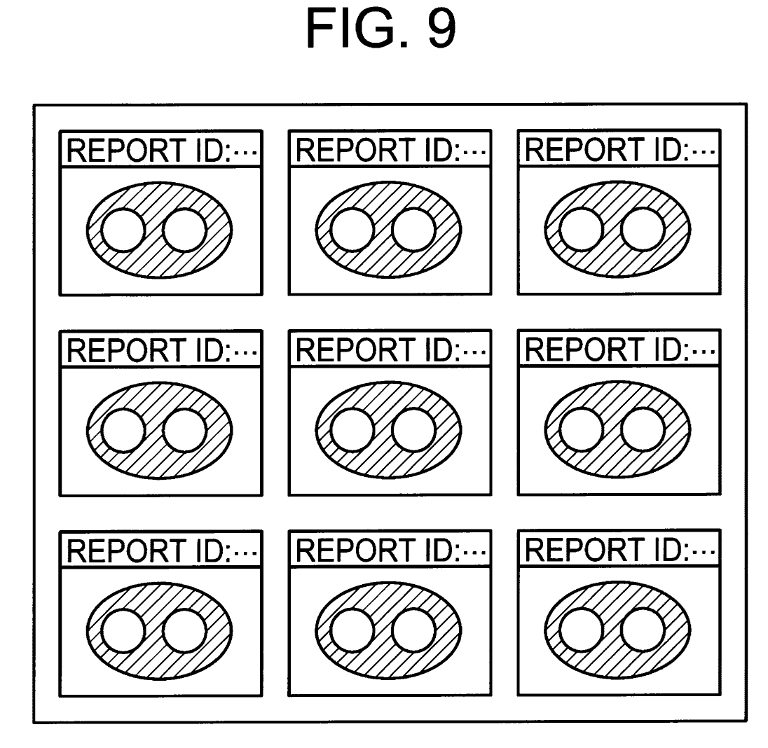

More specifically, the search part 34 generates a list of radiology reports 60 in which the report ID 62 paired with the organ information 81 transmitted as the search criterion from the report generation device 2 is stored, and transmits the list to the report generation device 2. When a radiology report 60 to be viewed is selected from the transmitted list in the report generation device 2, the search part 34 transmits the selected radiology report 60 to the report generation device 2. FIG. 9 is a schematic view illustrating the list to be generated. The list of the radiology reports 60 shows the report ID 62 and the medical image 71 associated with the storage destination address 72 paired with the organ information 81, as information that identifies the radiology reports 60. The search part 34 accesses the image server 5 to acquire the medical images 71 existing in the storage destination represented by the storage destination address 72, and thumbnails the medical images 71 to show.

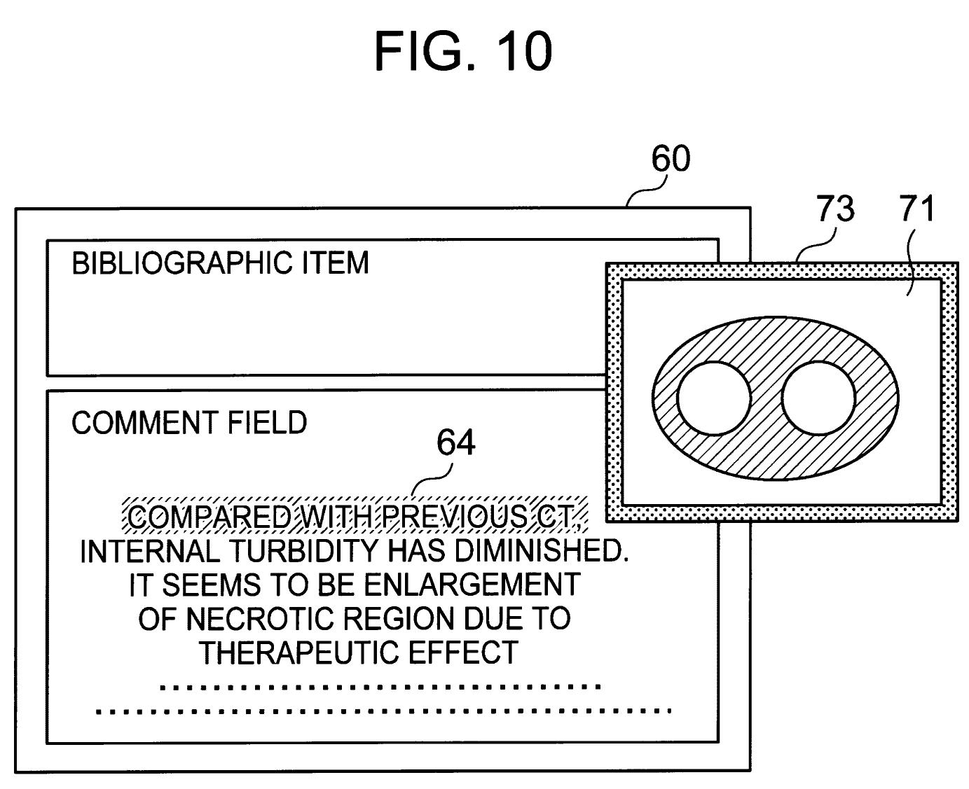

Further, the search part 34 transmits the medical image 71 shown in the list with the selected radiology report 60. FIG. 10 is a schematic view illustrating an example of the radiology report 60 transmitted with the medical image 71. The search part 34 may display the string 61 with highlight 64 enclosed by the link tag and the end tag of the link information 63 to which the organ information 81 received as the search criterion is attached, and may apply the same color of outlining 73 to the medical image 71 transmitted together. The search part 34 may include the examination date, disease name, etc., recorded in the searched radiology report 60 as information that identifies the radiology report 60. Further, the search part 34 may simply transmit the selected radiology report 60.

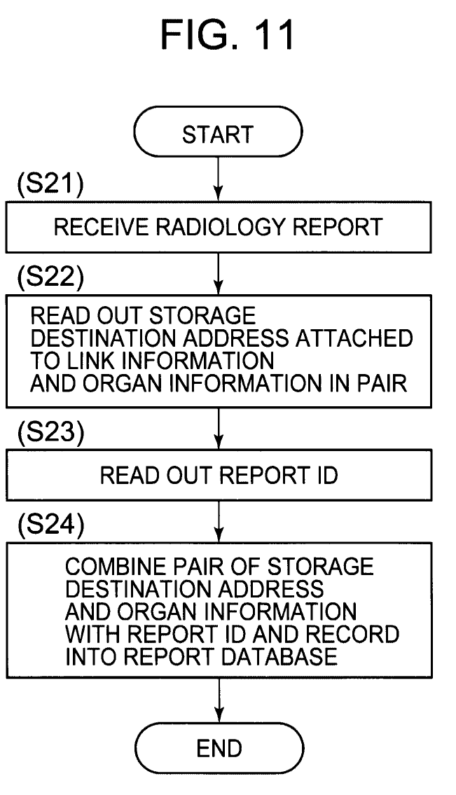

FIG. 11 is a flow chart illustrating an operation of registering into the report database 33 by the report storage device 3. Upon reception of the radiology report 60 from the report generation device 2 (S21), in a case that the link information 63 is attached to the received radiology report 60, the registering part 32 reads out the storage destination address 72 and the organ information 81 attached to the link information 63 in pair (S22), and additionally reads out the report ID 62 (S23). For example, in the radiology report 60 having the report ID 62 representing “001”, the storage destination address 72 representing “image server 5/image/yamada/medical image P. jpg” and the organ information 81 representing “stomach” are attached to the same link information 63, and the storage destination address 72 representing “image server 5/image/yamada/medical image Q. jpg” and the organ information 81 representing “stomach fundus” are attached to the same link information 63 different from the above. In this case, the pair of the storage destination address 72 representing “image server 5/image/yamada/medical image P.jpg” and the organ information 81 representing “stomach,” the pair of the storage destination address 72 representing “image server 5/image/yamada/medical image Q.jpg” and the organ information 81 representing “stomach fundus,” and the report ID 62 representing “001” are read out of the radiology report 60.

Upon reading out the pair of the storage destination address 72 and the organ information 81 as well as the report ID 62, the registering part 32 records the pair of the storage destination address 72 and the organ information 81 as well as the report ID 62 in combination into the report database 33 (S24). In a case that the organ information 81 and the report ID 62 are read out, the registering part 32 records the organ information 81 and the report ID 62 in combination into the report database 33. For example, the registering part 32 records the pair of the storage destination address 72 representing “image server 5/image/yamada/medical image P. jpg” and the organ information 81 representing “stomach,” the pair of the storage destination address 72 representing “image server 5/image/yamada/medical image Q. jpg” and the organ information 81 representing “stomach fundus,” and the report ID 62 representing “001” in combination into the same record.

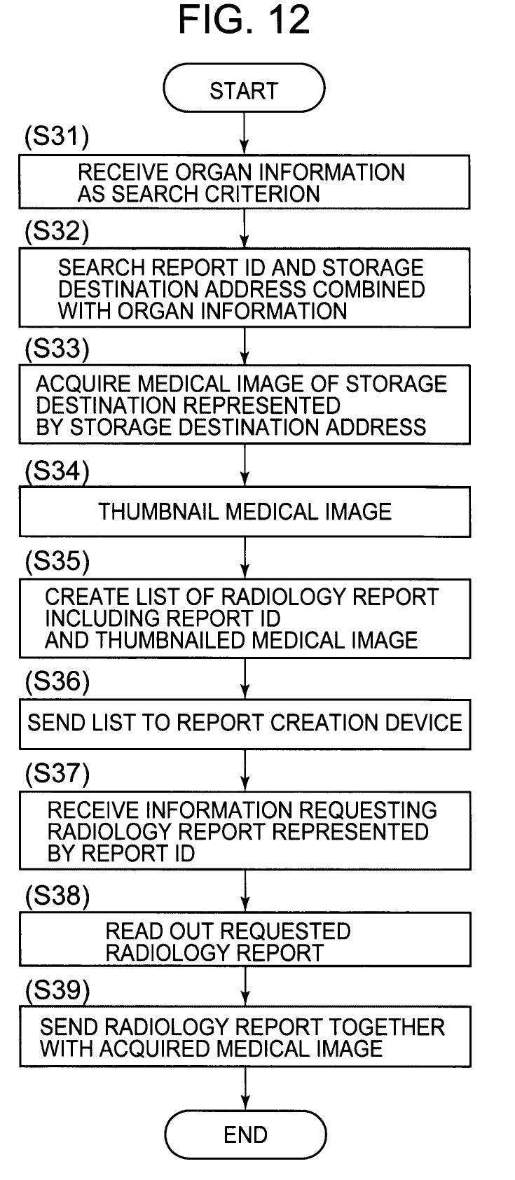

FIG. 12 is a flow chart illustrating an operation of searching the report database 33 by the report storage device 3. Upon reception of the organ information 81 as the search criterion from the report generation device 2 (S31), the search part 34 refers to the report database 33, and searches the report ID 62 and the storage destination address 72 that are combined with the received organ information 81 (S32).

Upon finding the relevant information, the search part 34 acquires the medical image 71 at the storage destination represented by the relevant storage destination address 72 from the image server 5 (S33), and thumbnails the medical image 71 (S34). Then, the search part 34 generates a list of radiology reports 60 including the relevant report ID 62 and thumbnailed medical images 71 (S35), and transmits the list to the report generation device 2 (S36).

Upon reception of the report ID 62 for requesting the radiology report 60 selected from the list from the report generation device 2 (S37), the search part 34 reads out the radiology report 60 having the received report ID 62 from the report storage 31 (S38), and transmits the radiology report 60 and the previously acquired medical image 71 to the report generation device 2 (S39). For example, the combination of the organ information 81 representing “stomach,” the storage destination address 72 representing “image server 5/image/yamada/medical image P. jpg,” and the report ID 62 representing “001” is registered in the report database 33, and the organ information 81 representing “stomach” is received as the search criterion. At this moment, the search part 34 searches the records including the organ information 81 representing “stomach” from the report database 33, and reads out the report ID 62 representing “001” included in the found records. The search part 34 then makes a list of the radiology reports 60 in which the report ID 62 representing “001” is recorded, and transmits the list to the report generation device 2. In the case of including the medical image 71 in the list as information that identifies the radiology report 60, the search part 34 also reads out the storage destination address 72, and acquires and thumbnails the medical image 71 from the storage destination represented by “image server 5/image/yamada/medical image P. jpg.”

In the report generation device 2, the image controller 26 controls the report generation screen display 21 to display the list. In a case that the medical image 71 is included in the list as information identifying the radiology report 60, such a list is displayed that thumbnailed medical images 71 are arranged as information identifying the radiology reports 60. When the report ID 62 of “001” representing the radiology report 60 selected from this list is transmitted, the search part 34 reads out the radiology report 60 in which the report ID 62 representing “001” is recorded, from the report storage 31, and transmits the radiology report 60 to the report generation device 2. Alternatively, the search part 34 also transmits the medical image 71 acquired from the storage destination represented by “image server 5/image/yamada/medical image P. jpg.” For example, before the transmission, the search part 34 applies the highlight 64 to the string 61 linked with the link information 63 to which the organ information 81 representing “stomach” is attached, and applies the same color of outlining 73 to the acquired medical image 71.

Thus, in response to an operation of designating a single medical image 71 being displayed and body-area information of this medical image 71, the report generation support system 1 links the designated body-area information to the radiology report 60. The report generation support system 1 then associates the radiology report 60 with the body-area information linked to this radiology report 60, and registers them into the report database 33. When single body-area information is designated, the report generation support system 1 searches for the radiology report 60 associated with the designated body-area information based on the report database 33. For example, the report generation support system 1, in response to a linking operation of designating a single medical image 71 being displayed and body-area information of this medical image 71, records the link information 63 representing the storage destination of the medical image 71 and the designated body-area information into the radiology report 60. Consequently, it becomes easy to search for previous radiology reports 60 connected with various body areas.

Further, the report generation support system 1 is configured so that body-area information and the object 82 representing this body-area information are linked and stored, the object 82 is displayed as the body-area information and, when the dragged medical image 71 is dropped onto the object 82, the dragged medical image 71 and the body-area information linked to the object 82 onto which the dragged medical image 71 has been dropped are linked to the radiology report 60. Consequently, the body-area information and the radiology report 60 are connected by a simple drag-and-drop operation that is general linking, so that the radiologist does not need to execute a complicated operation.

Although an example of attaching the storage destination address 72 of the medical image 71 to the link information 63 is described above, other than a mode of directly designating a file name such as the storage destination address 72, a mode of indirectly specifying the medical image 71 such as a search key may also be adopted as far as information that specifies the image server 5 in which the medical image 71 is stored and the ID of the medical image 71 are included. In other words, the storage destination address 72 and other image specification information should be attached to the link information 63. This is because, if information that specifies the medical image 71 is attached, it is possible to uniquely specify and acquire the medical image 71 by using the information as the search key.

Further, for example, the report generation support system 1 may be configured to, in response to an operation of designating a single medical image 71 being displayed and body-area information of this medical image 71, record the designated medical image 71 and the body-area information into the radiology report 60. In this case, the image link processor 291 does not paste image specification information as a hyperlink, but operates as a part to execute a process of pasting an image itself (hereinafter, referred to as an image paste processor).

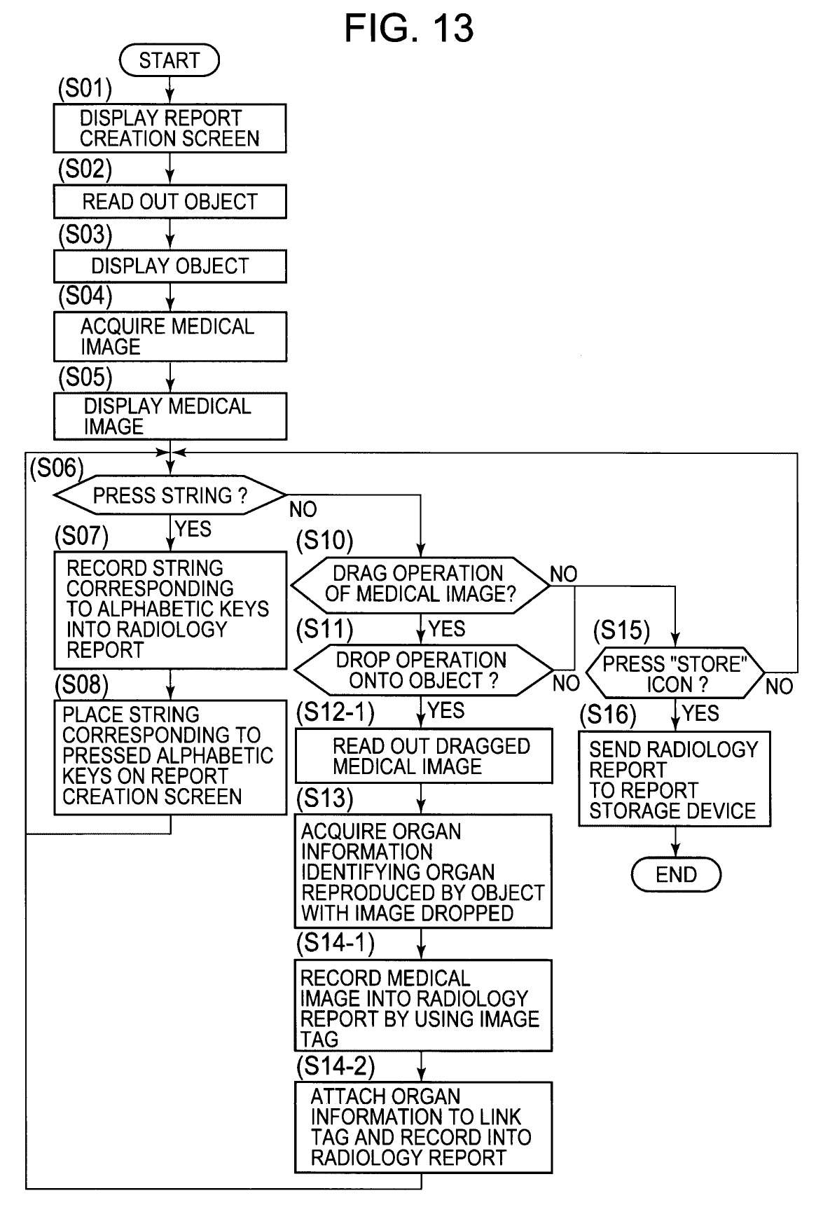

An example of a report generation operation by the report generation device 2 in the case of recording the medical image 71 into the radiology report 60 will be described based on FIG. 13. The same steps as in the report generation operation described in FIG. 6 will be denoted by the same step numbers.

First, the image controller 26 controls the report generation screen display 21 to display the report generation screen 211 (S01). Next, the image controller 26 reads out the object 82 stored in the object storage 28 (S02), and controls the viewer screen display 22 to display the object 82 (S03). The transceiver 27 acquires the medical image 71 represented by the storage destination address 72 specified in response to an operation of the operation part 23 via the network N, and controls the image storage 252 to store the medical image 71 (S04). The image controller 26 reads out the medical image 71 from the image storage 252, and controls the viewer screen display 22 to display the medical image 71 (S05). Then, the image controller 26 places a string onto the report generation screen 211 in response to press of the alphabetic keys (S06 to S08).

When the drag operation 221 is executed on the medical image 71 displayed on the viewer screen display 22 (S10, Yes) and the drop operation 222 of dropping the medical image 71 onto the object 82 displayed on the viewer screen display 22 is executed (S11, Yes), the link processor 29 starts a linking process. Here, in a case that data itself of the medical image 71 is recorded into a comment field, designation of a string to be linked is unnecessary, and the process of S09 is omitted.

In the linking process, the image paste processor reads out the medical image 71 on which the drag operation 221 has been executed, from the image storage 252 (S12-1). At the same time, based on the object ID 83 of the object 82 with the medical image 71 dropped, the organ-information link processor 292 acquires the organ information 81 identifying the organ reproduced by the object 82 with the medical image 71 dropped, from the organ-information storage 293 (S13).

Upon acquisition of the medical image 71, the image paste processor records the acquired medical image 71 into the radiology report 60 (S14-1).

In the recording into the radiology report 60, for example, the image paste processor pastes the data of the medical image 71 to the comment field of the radiology report 60, and attaches information representing that the data of the medical image 71 is image data. Because specified by the information representing being image data, the data of the medical image 71 may be recorded anywhere in the comment field, including the header.

Further, upon acquisition of the organ information 81, the organ-information link processor 292 further attaches the organ information 81 to the data of the pasted medical image 71 to record it into the radiology report 60 (S14-2).

When the icon 213 for storage is pressed down with the mouse of the operation part 23 (S15, Yes), the transceiver 27 reads out the radiology report 60 from the report-data storage 251 and transmits it to the report storage device 3 (S16).

This example also facilitates search of a previous radiology report 60 connected with each area of a human body. In this example, in an operation of registering into the report database 33, the registering part 32 reads out the organ information 81 with reference to the information representing being image data, and combines the image specification information included in the medical image 71 with the report ID 62, thereby recording them into the report database 33.

Further, by recording the body-area information attached to the image specification information and the medical image 71 in response to a hyperlink operation and an operation of pasting the medical image 71, it is possible to automatically present the medical image 71 represented by the body-area information designated as the search criterion.

Further, in search of a radiology report 60, a list including a medical image 71 as information identifying the radiology report 60 is generated.

Consequently, it is possible to select a desired radiology report 60 more viscerally than in the case of showing information identifying the radiology report 60 such as the examined site and the examination date in the list.

The body-area information may be attached to other information area such as the header of the radiology report 60, other than attached to the image specification information, and may be recorded in another file associated with the radiology report 60. Moreover, the organ information 81 is exemplified as the body-area information, but it may be information representing an area obtained by segmentalizing an organ such as the upper part of the stomach, or may be information representing an area obtained by segmentalizing a site such as a shoulder, or may be stored linked to the object 82 representing such information.

The report generation device 2 may be composed of a single computer, or may be composed of a computer for generating the radiology report 60 and another computer for displaying the medical image 71 and the object 82.

When the report generation device 2 is composed of separate computers, the computer for generating the radiology report 60 is provided with the report generation screen display 21, the computer for displaying the medical image 71 and the object 82 is provided with the viewer screen display 22, and communication between these computers is established by LAN connection, etc., so that the linking process and a process of moving the cursor are interlocked. In other words, the cursor can be moved from the report generation screen display 21 to the viewer screen display 22 and vice versa. Furthermore, information that identifies the dragged medical image 71 and the object 82 onto which the medical image 71 has been dropped, and information that represents the drag and drop are conveyed by the computer for displaying the medical image 71 and the object 82 to the computer for displaying the radiology report 60.

What is claimed is:

1. A report generation support system, comprising:
a storage configured to previously store body-area information identifying various areas of a human body;
a display configured to display a report generation screen, a medical image, and the body-area information;
a word processor configured to record a string into a radiology report in response to an operation of inputting the string; and
a link processor configured to, in response to an operation of designating at least one medical image and the body-area information that are displayed, link the designated medical image and the designated body-area information to the radiology report.

2. The report generation support system according to claim 1, wherein:
the link processor records the designated body-area information into the radiology report as the link.

3. The report generation support system according to claim 1, wherein:
the link processor records link information specifying the designated medical image into the radiology report as the link.

4. The report generation support system according to claim 1, wherein:
the link processor records the designated medical image into the radiology report as the link.

5. The report generation support system according to claim 1, further comprising:
a registering part configured to associate a generated radiology report with the body-area information linked to the radiology report and register them into a database; and
a search part configured to, when body-area information is designated as a search criterion, search a radiology report associated with the body-area information designated as the search criterion, based on the database.

6. The report generation support system according to claim 1, wherein:
the storage further stores an object corresponding to the body-area information;
the display displays the object instead of the body-area information; and
in response to an operation of dropping a dragged medical image onto the object, the link processor links the dragged medical image and the body-area information corresponding to the object with the medical image dropped, to the radiology report.

7. The report generation support system according to claim 1, wherein:
the link processor records link information specifying the designated medical image into the radiology report as the link, and attaches the body-area information to the link information to record it into the radiology report.

8. The report generation support system according to claim 7, further comprising:
a registering part configured to associate a generated radiology report with the body-area information linked to the radiology report and register them into a database; and
a search part configured to, when body-area information is designated as a search criterion, search a radiology report associated with the body-area information designated as the search criterion based on the database, and generate a list including a medical image of a storage destination represented by the link information with the body-area information attached, as information identifying the radiology report.

9. The report generation support system according to claim 1, wherein:
the body-area information is organ information representing an organ.
